(19) United States
(12) Patent Application Publication
(10) Pub. No.: US 2022/0378054 A1
(43) Pub. Date: Dec. 1, 2022

(54) Meat or Vegetable Filled Pizza Dough Edge or Crust Edge

(71) Applicant: William Redvers Belisle, New Orleans, LA (US)

(72) Inventor: William Redvers Belisle, New Orleans, LA (US)

(21) Appl. No.: 17/350,035

(22) Filed: Jun. 17, 2021

Related U.S. Application Data
(60) Provisional application No. 63/195,557, filed on Jun. 1, 2021.

(51) Int. Cl. A21D 13/31; A21D 13/38; A21D 10/02; A21D 13/41

(52) U.S. Cl. CPC A21D 13/31; A21D 13/38; A21D 10/025; A21D 13/41

(57) ABSTRACT

Regular or flattened pizza dough edges made with meat, vegetables, or sauce placed atop or within pizza dough edges and with pizza dough edges rolled over or pinched to enclose meat, vegetables, or sauce within edges to form meat, vegetables, or sauce filled pizza crust. The pizza dough edges and filled pizza edge crust are prepared with or without the pizza center and are prepared before, during, or after pizza center is prepared. The invention is made for fresh cooking or frozen for later cooking. The invention will contribute to the taste and options for freshly made and frozen pizza.

### CROSS-REFERENCE TO RELATED APPLICATIONS

1. Cole, Frank, and Hairsine, Alan, Nov. 12 2002. “Cheese depositing method” (U.S. Pat. No. 6,479,087)

2. Sanguinetti, Paul, Nelson, Rick L., Dungan, David M., and Hayward, Richard L., Apr. 11, 2000. “Method for making a stuffed pizza crust” (U.S. Pat. No. 6,048,556)

3. Sanguinetti, Paul, Nelson, Rick L., Dungan, David M., and Hayward, Richard L., Feb. 2, 1999. “Apparatus for making a stuffed pizza crust” (U.S. Pat. No. 5,865,107)

4. Kostival, K., Ross, Robert, and Yoakum, J. T., Sep. 14, 2004. “Ready to bake dough with shaped, coextruded filling and method of making same” (U.S. Pat. No. 6,790,467)

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

### 1. Field of the Invention/Technical Field

The following is ‘A statement of the field of art to which the invention pertains’:

1. U.S. Class 426 Field of Search: 426/283; 426/502; 426/516; 426/517; 426/520; 426/523

2. U.S. Class 426 Field of Search: 426/94; 426/274; 426/275; 426/283

3. U.S. Class 99 Field of Search: 99/450.6; 99/450.1; 99/450.7

4. U.S. Class 426 Field of Search: 426/94; 426/128; 426/144; 426/283; 426/76

### 2. Description of the Related Art

Cole and Hairsine (November, 2002) describe the depositing of cheese on the periphery of pizza crust providing a cheese stuffed rim.

Sanguinetti et al. (April, 2000) describe a lower uncooked crust dough combined with an upper baked crust with edible filling material between the lower and upper layers.

Sanguinetti et al. (February 1999) describe a lower uncooked crust dough combined with a upper baked crust with edible filling material between the lower and upper layers.

Kostival, et al. (September, 2004) describe a ready to bake dough product with a shaped liquid, creamy, or pasty filling.

The prior art does not describe a meat or vegetable filled pizza dough edge or pizza crust edge. The present invention attempts to provide such meat or vegetable filled pizza dough edge or pizza crust edge.

### BRIEF SUMMARY OF INVENTION

It is the objective of the invention to provide meat, vegetables, or sauce filled pizza dough edge or pizza crust edge. The claimed invention is usable with freshly made pizza or frozen and cooked later pizza, can be made separately from the pizza center and may be added to the pizza center, and the pizza dough edge, meat, vegetables, or sauce may be made before, with, or after the pizza center.

### BRIEF DESCRIPTION OF THE SEVERAL VIEWS OF THE DRAWINGS

The present invention will be fully understood by reference to the following brief description thereof when read in conjunction with the attached drawings, and wherein:

FIG. 1. FIG. 1 depicts a top view of a pizza dough showing a one inch edge of the pizza dough and the pizza dough center.

FIG. 2. FIG. 2 depicts a cross sectional view of a meat, vegetables, or sauce filled rolled pizza dough crust.

### DETAILED DESCRIPTION OF THE INVENTION

Present methods of pizza crust stuffing or filling generally include cheese-stuffed pizza crust. The present invention provides method of making raw, one quarter, one half, three quarters, or fully cooked meat, vegetables, or sauce filled pizza dough edge or crust edge.

The Figures depict the appearance of, and the manner in which the device is made.

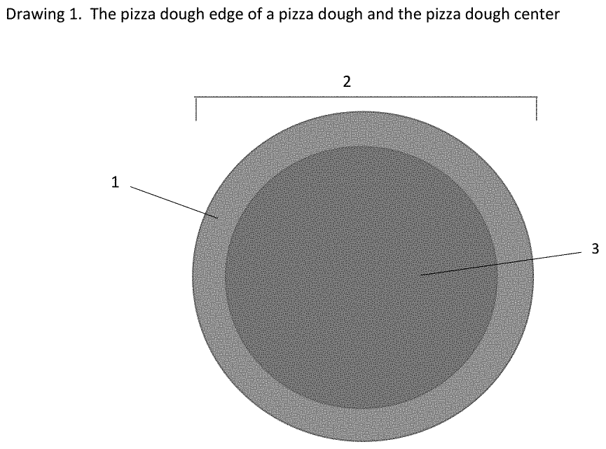

FIG. 1 depicts the pizza dough edge, 1, around a pizza, 2, with a pizza center, 3, the pizza edge becoming pizza crust when cooked. A one tenth to nine tenths pizza crust diameter-sized raw, quarter, half, three quarters or fully cooked meat, vegetables, or sauce single, straight, or ring-shaped portion physically or mechanically positioned or placed in the center of 1, 3, 6, 10, 15, 20, and 25 inch diameter said pizza edge or crust. Said pizza edge or crust is comprised of the outer one inch edge portion of round and square flattened pizza dough and said meat, vegetables, or sauce manually or mechanically placed centrally atop or to the exterior of said pizza dough edge or pushed into the center of said dough and said edges are rolled over to enclose and seal in said meat, vegetables, or sauce and forming said filled pizza edge or pizza crust.

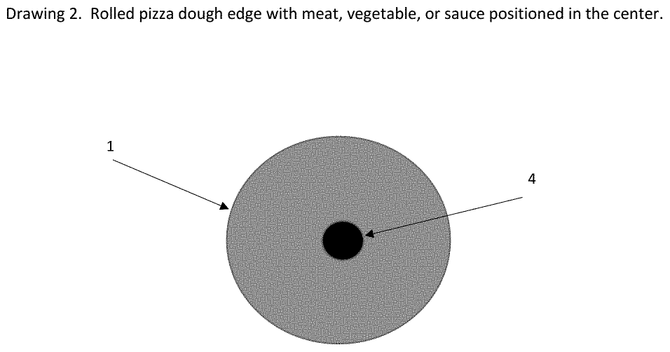

FIG. 2 depicts the pizza dough edge, 1, rolled over enclosing the meat, vegetables, or sauce, 4, forming said filled pizza edge or pizza crust. The dough edge may be made thicker than or flattened or prepared thinner than said pizza center dough. The meat, vegetables, or sauce may be placed on or into said pizza crust edge or said dough edge prior to cooking. The pizza crust can be made for fresh-cooking or frozen or packaged for later cooking. The pizza edge or crust cooking time four to sixty minutes at seventy-five to seven hundred degrees. The pizza edge or crust dough and said meat, vegetables, or sauce can be made before, with, or after said pizza center is made and added to said pizza center.

What is claimed is:

1. A one tenth to nine tenths pizza dough edge or crust edge diameter-sized raw, quarter, half, three quarters or fully cooked meat or vegetables single, straight, or ring-shaped portion filled 1, 3, 6, 10, 15, 20, and 25 inch diameter said pizza dough edge or crust edge comprised of:
the outer one inch edge portion of round and square flattened pizza dough and said meat or vegetables manually or mechanically placed centrally atop or to the exterior of or pushed into said pizza dough edge or crust edge and said edges are rolled over to enclose and seal in said meat or vegetables and forming said filled pizza edge or crust edge.

2. The filled pizza dough edge or crust edge in claim 1, wherein said dough edge may be made thicker than or flattened or prepared thinner than said pizza center dough.

3. The filled pizza dough edge or crust edge in claim 2, wherein said meat or vegetables may be placed on or into said pizza crust edge or said dough edge prior to cooking.

4. The filled pizza dough edge or crust edge in claim 3, wherein said pizza crust edge can be made for fresh-cooking or frozen or packaged for later cooking.

5. The filled pizza dough edge or crust edge in claim 4, wherein said pizza crust edge cooking, time is four to one hundred and twenty minutes at seventy-five to seven hundred degrees.

6. The filled pizza dough edge or crust edge in claim 1, wherein said pizza crust edge or dough edge and said meat or vegetables can be made before, with, or after said pizza center is made and added to said pizza center.

7. The filled pizza dough edge or crust edge in claim 1, wherein said filling includes sauce.

8. The filled pizza dough edge or crust edge in claim 1, wherein water or oil may be added to said meat or vegetables for cooking consistency.
